(19) United States
(12) Patent Application Publication
(10) Pub. No.: US 2021/0371311 A1
(43) Pub. Date: Dec. 2, 2021

(54) METHOD OF PURIFYING LAKE WATER USING NANO AND MICRO BUBBLE

(71) Applicant: GSL BIO Co., Ltd, Jeju-si (KR)

(72) Inventors: Young Mi Kim, Jeju-si (KR); Chon Ho Lee, Jeju-si (KR); Yo Seph Cho, Seogwipo-si (KR)

(21) Appl. No.: 17/004,946

(22) Filed: Aug. 27, 2020

(30) Foreign Application Priority Data
May 27, 2020 (KR) 10-2020-0063879

(51) Int. Cl. C02F 3/20; C02F 3/34

(52) U.S. Cl. CPC C02F 3/20; C02F 2103/007; C02F 3/341

(57) ABSTRACT

The present invention relates to a method of purifying lake water using nano and micro bubbles, and more specifically, relates to a method of purifying lake water using nano and micro bubble comprising the steps of: contacting a first microbial fermentation broth to the green algae-generating treatment water area or the malodor-generating treatment water area by spraying means so that the green algae components and the malodorous components are decomposed; treating with nano bubbles in which nano bubbles generated by a nano-micro bubble generator selectively generating nano bubbles and micro bubbles are introduced into the lower portion of the treatment water area; and treating with micro bubbles mixed with microorganisms in which micro bubbles mixed with a second microbial fermentation broth are introduced into the lower portion of the treatment water area from a mixer in which micro bubbles generated by the nano-micro bubble generator and the second microbial fermentation broth supplied from a microbial injection unit are mixed.

### CROSS-REFERENCE TO RELATED APPLICATIONS

This application claims priority to Korean Patent Application No. 10-2020-0063879 filed on May 27, 2020, the disclosure of which is expressly incorporated herein by reference.

### STATEMENT RE: FEDERALLY SPONSORED RESEARCH/DEVELOPMENT

Not Applicable

### BACKGROUND

### 1. Technical Field

The present invention relates to a method of purifying lake water using nano and micro bubbles, and more specifically, relates to a method of purifying lake water using nano and micro bubble that can remove the green algae and malodor generated in the lake water through nano bubble treatment and micro bubble treatment in which microorganisms are mixed after the first spray treatment with a highly active microbial fermentation broth for controlling green algae, and thereby the treated water can be reused as an agricultural water and the like.

### 2. Background Art

In general, a lake refers to an aquatic system in which water flowing in a certain space stays for a certain period of time, and is classified into lakes, swamps, ponds, and wetlands. At the beginning of the lake formation, the concentration of nutrient salts is low, and production and consumption in a water system are balanced to maintain a poor nutritional state, but as the time lapses, the concentration of nutrient salts gradually increases due to the isolated environment, and algae proliferate excessively, thereby undergoing eutrophication.

The eutrophication is a phenomenon that occurs when algae activity is active as forest humus fertilizer used in agricultural land, and manure from livestock products that can be nutrients for the reproduction of algae, such as nitrogen (N), phosphorus (P), synthetic detergents, as well as substances such as various sewage and factory wastewater, etc. are accumulated in the lake.

In such a lake with active algae activity, eutrophication proceeds at a faster rate than natural conditions, and nutrient salts continue to flow into the lake in various forms, and when the lake's self-cleaning capacity is exceeded, water pollution gradually occurs, and this process is further promoted by repetition of stratification and turnover phenomena of the lake.

The lake eutrophied by the above process causes serious problems such as coloration of lake water, malodor, decrease in transparency and increase in turbidity, anaerobicization at the bottom of the lake, decrease of dissolved oxygen, and death of fishes and shellfishes due to abnormal growth of algae. As a result, aquatic ecosystems are rapidly destroyed and cannot be revived through self-cleaning.

As such a lake purification technology, a closed lake suppressing the occurrence of green algae and reduces the occurrence of malodor by reducing the load of pollutants with a physical filtration method that removes suspended solids, and by removing organic substances, nitrogen, phosphorus, and the like by biological treatment method, and a circulating water purification system to lake or pond (registered patent No. 10-0697985) capable of creating an artificial water channel have been studied.

Meanwhile, nano bubble and micro bubble technologies have been applied to water treatment technology to decompose organic matter and are being studied. As such a prior art, Patent No. 10-1443835 relates to an advanced sewage treatment equipment using an automatic control ozone nano-micro bubble generator and a batch-type flotation tank, in which a technology is disclosed wherein an automatic control batch-type flotation tank using ozone nano micro bubble is installed at the backend of the advanced batch-type activated sludge treatment process, so that processing water is processed to a level that can be reused through the secondary treatment by oxidation, flotation, and sterilization mechanisms in the batch-type flotation tank by introducing the primary treated water (BOD, SS 5˜10 PPM or less). FIG. 1 is a block diagram showing the internal configuration of the ozone nano-micro bubble equipment of the prior art, wherein the ozone nano-micro bubble generator 60 is configured to comprise a pressure pump 63, a nano-micro bubble generator 64, and an air compressor 65, and an ozone generator 66. The pressure pump 63 is connected to a suction nozzle 61 to suck the treated water from the batch floating tank 50 and supply it to the nano-micro bubble generator 64. The air compressor 65 and the ozone generator 66 generate compressed air and ozone, respectively, and provide them to the nano-micro bubble generator 64.

However, in the prior art, ozone nano-micro bubbles were applied for the purpose of removing organic matter from the river, but lakes and reservoirs where eutrophication and green algae are severely progressed have limitations in the removal rate of organic matter due to organic matter deposited under the lower portion, so there are difficulties in processing to a level that can be reused.

The inventors of the present invention were investigating a method for purifying the water quality of a lake using nano and micro bubbles, and it was confirmed that after the first spray treatment with a highly active microbial fermentation broth for controlling green algae, the treated water can be reused in agricultural water and the like by removing the green algae and malodor occurred in the lake through the nano bubble treatment and micro bubble treatment mixed with microorganisms, and thereby the present invention has been completed.

### BRIEF SUMMARY

### 1. Technical Subject

Accordingly, an object of the present invention is to provide a method of purifying lake water using nano and micro bubbles capable of removing green algae and malodors generated in the lake and reusing treated water.

### 2. Technical Solution

To achieve the above described objectives, the present invention provides a method of purifying lake water using nano and micro bubbles comprising the steps of: contacting a first microbial fermentation broth to the green algae-generating treatment water area or the malodor-generating treatment water area by spraying means so that the green algae components and the malodorous components are decomposed (S10); treating with nano bubbles in which nano bubbles generated by a nano-micro bubble generator selectively generating nano bubbles and micro bubbles are introduced into the lower portion of the treatment water area (S20); and treating with micro bubbles mixed with microorganisms in which micro bubbles mixed with a second microbial fermentation broth are introduced into the lower portion of the treatment water area from a mixer in which micro bubbles generated by the nano-micro bubble generator and the second microbial fermentation broth supplied from a microbial injection unit are mixed (S30).

In addition, in a method of purifying lake water using nano and micro bubbles according to an embodiment of the present invention, the mixer unit is characterized in that it is provided with a stirrer unit for stirring the water formed with micro bubbles and the second microbial fermentation liquid.

In addition, in a method of purifying lake water using nano and micro bubbles according to an embodiment of the present invention of the present invention, the first microorganism fermentation broth is characterized in that it is manufactured through the steps of: obtaining a microbial fermented seed liquid through a fermentation and aging process by adding molasses and water to a mixed raw material wherein Lespedeza bicolor leaves, Lotus leaves, Houttuynia cordata, Scutellaria baicalensis, and Tabasheer are mixed; and obtaining a microbial fermentation broth containing Lactobacillus paracasei, Lactobacillus parafarraginis, and Lactobacillus havinensis wherein the microbial fermented seed liquid is filtered to obtain a microbial stock solution, and purified water and bay salt is added to the microbial stock solution followed by fermentation and aging.

In addition, in a method of purifying lake water using nano and micro bubbles according to an embodiment of the present invention, the second microbial fermentation broth is characterized is characterized by being cultivated after mixing of Lactobacillus harbinensis with Saccharomycopsis schoenii.

### 3. Advantageous Effects

According to a method of purifying lake water using nano and micro bubbles of the present invention, after the first spray treatment with a highly active microorganism fermentation broth for controlling green algae, green algae and malodors generated in the lake are removed through nano bubble treatment and micro bubble treatment with microorganisms to meet the effluent water quality standards and thereby the treated water can be reused for agricultural water and the like.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram showing the internal configuration of a conventional ozone nano-microbubble device.

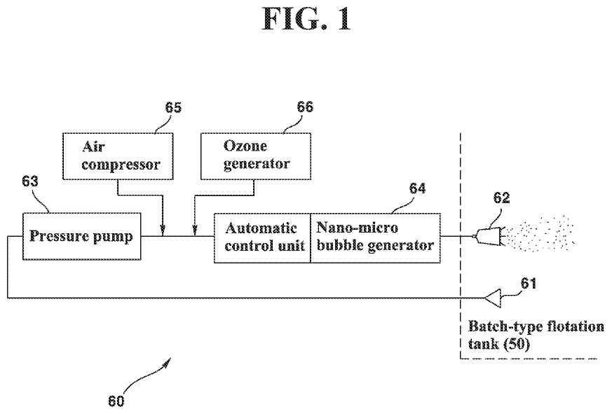

FIG. 2 is a flowchart of a method for purifying water quality in streams and lakes using nano and micro bubbles according to an embodiment of the present invention.

FIG. 3 is a schematic diagram explaining a configuration in which a first microbial fermentation broth is sprayed by spraying means into a treatment water area where green algae are generated according to an embodiment of the present invention.

### DETAILED DESCRIPTION

Since the present invention can be applied with various transformations and can have various embodiments, specific embodiments will be described in detail in the detailed description. Hereinafter, embodiments of the present invention will be described in detail with reference to the drawings.

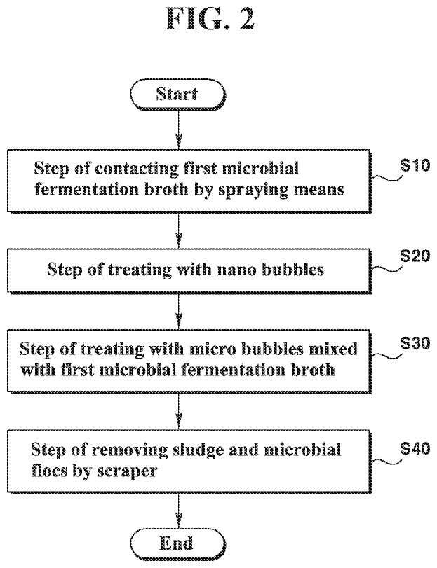

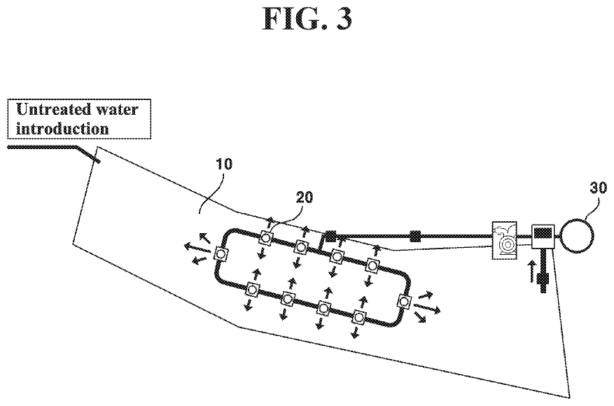

FIG. 2 is a flowchart of a method for purifying water quality in streams and lakes using nano and micro bubbles according to an embodiment of the present invention, and FIG. 3 is a schematic diagram explaining a configuration in which a first microbial fermentation broth is sprayed by spraying means into a treatment water area where green algae are generated according to an embodiment of the present invention.

Referring to FIGS. 2 to 3, a method of purifying lake water using nano and micro bubbles according to the present invention comprises the steps of contacting the first microbial fermentation broth to decompose green algae components and malodor components (S10); treating with nano bubbles (S20); and treating with micro bubbles in which microorganisms are mixed (S30).

The step of contacting the first microbial fermentation broth to decompose green algae components and odor components (S10) is to contact with a green algae generating treatment water area 10 or a malodor generating treatment area by a spraying means 20 connected to the tank 30 for storing the first microbial fermentation broth.

The first microbial fermentation broth is manufactured through the steps of obtaining a microbial fermented seed liquid through a fermentation and aging process by adding molasses and water to a mixed raw material wherein Lespedeza bicolor leaves, Lotus leaves, Houttuynia cordata, Scutellaria baicalensis, and Tabasheer are mixed; and obtaining a microbial fermentation broth containing Lactobacillus paracasei, Lactobacillus parafarraginis, and Lactobacillus havinensis wherein the microbial fermented seed liquid is filtered to obtain a microbial stock solution, and purified water and bay salt is added to the microbial stock solution followed by fermentation and aging.

The microbial spraying means 20 is installed in the center of the treatment water area, but the spraying means may be installed at regular intervals 1 m below the water surface (refer to FIG. 3). At this time, it is automatically sprayed at a predetermined time while the stagnant contaminated water at the bottom of the treatment water area is being pumped with a pump for circulation.

When the first microbial fermentation broth is sprayed into the green algae generating area, most of the green algae components in the upper portion of the green algae generating portion are decomposed, and malodor can also be removed. However, when organic matter is deposited in the lower portion of the green algae generating area as the green algae generation worsens, there is a limit in decomposition of the organic matter deposited in the lower portion of the green algae generating area only by spraying the first microbial fermentation broth. Accordingly, in order to solve this problem, the decomposition of organic matter deposited in the lower portion of the green algae generating area can be completely removed through the step of treating with nano bubbles (S20) and the step of treating with micro bubbles (S30) in which microorganisms are mixed.

The step of treating with nano bubbles (S20) is to introduce nano bubbles generated by the nano-micro bubble generator that selectively generates nano bubbles and micro bubbles into the lower portion of the treatment water area.

The nano and micro bubble generators are configured of a pressure pump, a nano-micro bubble generator, an air compressor, and an ozone nano bubble generator. The pressure pump is connected to a suction nozzle to suck the treated water from the lake and supply it to the nano-micro bubble generator. The air compressor and ozone nano bubble generator generate compressed air and ozone, respectively, and provide them to the nano-micro bubble generator. If the ozone nano bubble generator is commercially available, the manufacturer is not limited thereto.

In the case where ozone nano bubbles are generated, ozone is introduced by operating the ozone nano bubble generator while the treated water sucked through the pressure pump is supplied to the nano-micro bubble generator. The nano-micro bubble generator generates nano-sized bubbles of ozone-introduced treated water and sprays them into the lake through a spray nozzle. The size of the nano bubbles generated at this time has a range of approximately 0.1 μm to 1 μm.

The ozone nano-micro bubble generator operates to generate ozone nano bubbles, and is uniformly sprayed from the lower portion of the lake through the spray nozzle for a certain period of time, thereby oxidizing and sterilizing pollutants. When ozone nano bubbles are sprayed, the air bubbles become smaller as they are floating up to the surface of the water, and they disappear later, and pollutants are decomposed by the strong oxidizing power generated by the free radicals generated at this time. When ozone nano bubbles are introduced into water, the bubbles become smaller and as the bubbles are floating upward. Since the pressure inside the bubbles increases inversely proportional to the bubble diameter, the reduction of the bubbles leads to an increase in pressure, and if the speed is sufficiently fast, the temperature inside the bubble also increases rapidly by adiabatic and compressive action. As a result, when the air bubbles disappear, free radicals are generated by forming a region of high temperature and atmospheric pressure. Since free radicals generated at this time have high energy generated, high oxidizing power is generated in the process of changing to the original stable one and decomposes pollutants existing around it.

The ozone nano bubble treatment process in step S20 decomposes toxic components that adversely affect the activity of microorganisms attached to the micro bubbles in the post-process and kill other microorganisms, and thereby the activity of microorganisms can be increased in the micro bubble process.

After the contact reaction of the ozone nano bubbles is performed for a certain period of time, generation of ozone nano bubbles in the ozone nano-micro bubble generator stops, and the process proceeds to step S30 to generate micro bubbles. Micro bubbles can float decomposed contaminants and residual suspended matter most efficiently.

The step of treating with micro bubbles (S30) in which microorganisms are mixed is to introduce a second microorganism fermentation liquid in the lower portion of the treatment water from a mixer in which the micro bubbles generated by the nano and micro bubble generators and the second microorganism fermentation broth supplied from the microorganism injection unit are being mixed.

The micro bubbles mixed with the second microbial fermentation broth are attached to the microorganisms to form a micro cell structure, and when they are uniformly sprayed from the lower portion of the lake through the spray nozzle, they are decomposed by the microorganisms as the residual floating substances in the water adheres while floating toward the water surface. In other words, while the micro bubbles gradually rise, the amount of dissolved oxygen is increased in water where green algae are generated or likely to be generated, and the microorganisms mixed with micro bubbles decompose organic matter and suppress the occurrence of green algae, and it is removed after forming microbial flocs.

In the case of generating micro bubbles, air is introduced into the treatment water in the process of supplying the treatment water sucked through the pressure pump to the nano-micro bubble generator. The nano-micro bubble generator generates micro-sized bubbles from the treatment water introduced with air and sprays them into the lake through the spray nozzle. The size of the micro bubbles generated at this time has a range of approximately 10 μm to 50 μm.

The mixer is equipped with a stirrer for stirring the water formed with micro bubbles and the second microbial fermentation broth.

The second microbial fermentation broth is the one cultured by mixing Lactobacillus harbinensis and Saccharomycopsis schoenii.

In the case when the treated water is to be recycled, in step S40 after the step S30, the treated water is discharged after removing the floating sludge and microbial flocs floating above the water surface by a scraper.

Hereinafter, the present invention will be described in more detail through embodiments and experimental examples, but the following embodiments and experimental examples are for the purpose of explanation only, and are not intended to limit the scope of the present invention.

### EMBODIMENT

1000 ml of green algae raw water was collected in a flask from a reservoir with a thickness of 100 mm or more of the green algae layer and sprayed by spraying 30 ml of first microbial fermentation broth on the collected samples. At this time, for the first microbial fermentation broth, 200 kg, a mixture of 100 kg of Lespedeza bicolor leaves, 60 kg of Lotus leaves, 20 kg of Houttuynia cordata, 10 kg of Scutellaria baicalensis, and 10 kg of Tabasheer, was put into the bottom of a fermentation reaction vessel, and then 100 kg of purified water and 100 kg of molasses were added thereto, and when the fermentation and aging process was performed for 12 months in a fermentation chamber which was maintained at 30-35° C., it was possible to obtain a thick microbial fermented seed liquid with white mold growing on the top. A microbial fermentation stock solution was obtained by filtering a microbial fermented seed liquid, and 1 ton (1,000 kg) of purified water and 25 g of sea salt were added to 25 kg of the microbial fermentation stock solution, and fermented and aged for 15 days in a fermentation chamber which was maintained at 25 to 30° C. As a result of analyzing the microbial fermentation broth, a microbial fermentation broth containing Lactobacillus paracasei, Lactobacillus parafarraginis, and Lactobacillus harbinensis as representative strains were obtained.

2 days after spraying, ozone nano bubbles were injected into the bottom of the flask containing the sample for 1 hour to decompose organic matter in the sample, and subsequently, micro bubbles and 30 ml of a second microbial fermentation broth were mixed and injected into the bottom of the flask for 24 hours to reduce the organic matter concentration below the effluent water quality standard due to the decomposition of organic matter by microorganisms, and the generated microbial flocs were removed.

At this time, the second microbial fermentation broth was derived from the strain analyzed for the first microbial fermentation broth, which was mixed with micro bubbles and exhibited the optimum decomposition efficiency of organic matter, and it was cultured by mixing Lactobacillus harbinensis and Saccharomycopsis schoenii.

### COMPARATIVE EXAMPLE

In the same manner as in the above embodiments, in this Comparative Example, a Comparative Example was prepared according to the conditions of Table 1 (ingredient added: O, ingredient not added: X) compared to the above embodiment (see Table 1).

In Comparative Example 1, the order the step of treating with nano-bubbles and the step of treating with micro-bubbles mixed with microorganisms was switched such that the step of treating with micro-bubbles mixed with microorganisms was first performed, and then the step of treating with nano-bubbles was performed.

Each of Comparative Examples 2 to 6 is the one that was not treated or not injected with a first microbial fermentation broth, nano bubbles, micro bubbles, Lactobacillus havinensis, and Saccharomycopsis scoeni, respectively.

Comparative Example 7 used Lactobacillus Paracasei instead of Lactobacillus habinensis, and Comparative Example 8 used Saccharomycopsis fibuligera instead of Saccharomycopsis scoeni.

TABLE 1

| | First | Treated | Treated | | | | | |
|---|---|---|---|---|---|---|---|---|
| | microbial | with | with | | | | | |
| | fermentation | nano | micro | Lactobacillus | Saccharomycopsis | Lactobacillus | Saccharomycopsis | |
| Classification | broth | bubbles | bubbles | harbinensis | schoenii | Paracasei | fibuligera | Remarks |
| Embodiment | ◯ | ◯ | ◯ | ◯ | ◯ | X | X | |
| Comparative | ◯ | ◯ | ◯ | ◯ | ◯ | X | X | Nano |
| Example 1 | | | | | | | | bubble |
| | | | | | | | | treatment |
| | | | | | | | | after |
| | | | | | | | | micro |
| | | | | | | | | bubble |
| | | | | | | | | treatment |
| Comparative | X | ◯ | ◯ | ◯ | ◯ | X | X | |
| Example 2 | | | | | | | | |
| Comparative | ◯ | X | ◯ | ◯ | ◯ | X | X | |
| Example 3 | | | | | | | | |
| Comparative | ◯ | ◯ | X | ◯ | ◯ | X | X | |
| Example 4 | | | | | | | | |
| Comparative | ◯ | ◯ | ◯ | X | ◯ | X | X | |
| Example 5 | | | | | | | | |
| Comparative | ◯ | ◯ | ◯ | ◯ | X | X | X | |
| Example 6 | | | | | | | | |
| Comparative | ◯ | ◯ | ◯ | X | ◯ | ◯ | X | |
| Example 7 | | | | | | | | |
| Comparative | ◯ | ◯ | ◯ | ◯ | X | X | ◯ | |
| Example 8 | | | | | | | | |

### EXPERIMENTAL EXAMPLE

For the treatment water treated according to the Embodiment and Comparative Example, the measurement results of the concentration (weight ppm) of chemical oxygen demand (COD), suspended solids (SS), total nitrogen (T-N) and total phosphorus (T-P) of the treatment water according to the water pollution process test method are shown in Table 2.

TABLE 2

| | COD | | SS | | T-N | | T-P | |
|---|---|---|---|---|---|---|---|---|
| Classification | Before | After | Before | After | Before | After | Before | After |
| (Weight ppm) | treatment | treatment | treatment | treatment | treatment | treatment | treatment | treatment |
| Embodiment | 18.6 | 2.1 | 28.4 | 3.6 | 1.33 | 0.53 | 0.26 | 0.02 |
| Comparative | 18.1 | 9.6 | 28.2 | 12.4 | 1.32 | 0.61 | 0.27 | 0.03 |
| Example 1 | | | | | | | | |
| Comparative | 18.7 | 11.4 | 27.5 | 10.9 | 1.34 | 0.52 | 0.26 | 0.02 |
| Example 2 | | | | | | | | |
| Comparative | 18.3 | 10.3 | 28.9 | 11.5 | 1.33 | 0.55 | 0.25 | 0.04 |
| Example 3 | | | | | | | | |
| Comparative | 18.8 | 9.4 | 27.6 | 12.8 | 1.32 | 060 | 0.27 | 0.03 |
| Example 4 | | | | | | | | |
| Comparative | 18.7 | 9.8 | 28.8 | 10.4 | 1.33 | 0.54 | 0.28 | 0.06 |
| Example 5 | | | | | | | | |
| Comparative | 18.5 | 10.1 | 28.3 | 11.5 | 1.32 | 0.58 | 0.25 | 0.04 |
| Example 6 | | | | | | | | |
| Comparative | 18.6 | 9.7 | 28.9 | 11.6 | 1.31 | 0.57 | 0.26 | 0.05 |
| Example 7 | | | | | | | | |
| Comparative | 18.4 | 9.9 | 27.3 | 10.8 | 1.34 | 0.58 | 0.27 | 0.03 |
| Example 8 | | | | | | | | |

As shown in Table 2 above, it can be seen that in Embodiment, a significant decrease in concentration appeared after treatment in COD, SS, T-N and T-P.

Comparative Example 1, in which the step of treating with micro bubbles mixed with microorganisms was performed first and then the step of treating with nano bubbles was performed, shows that there was no significant change in COD and SS concentrations. This fact is confirmed in that in the case of Embodiment, by treating with nano bubbles first, toxic components that adversely affect the activity of microorganisms attached to micro bubbles in the post-process were decomposed and other microorganisms were killed, so that the activity of microorganisms attached to micro bubbles in the post process was maintained, and thereby the concentration of COD and SS could be significantly reduced, and on the contrary, for the case of Comparative Example 1, as the step of treating with nano bubbles was changed to be performed after the step of treating with micro bubbles, it is believed that such effect could not be expected.

Comparative Examples 2 to 8 showed that the decrease in the concentration of T-N and T-P after the treatment was not significantly different from that of Embodiment, but it can be seen that there is no relatively large change in the concentration of COD and SS. Comparative Example 7 uses Lactobacillus paracasei instead of Lactobacillus havinensis, and Comparative Example 8 uses Saccharomycopsis fibuligera instead of Saccharomycopsis scoeni, and it shows a remarkably increased decomposition efficiency when a mixed strain consisting of Lactobacillus harbinensis and Saccharomycopsis schoenii was used as a second microbial fermentation broth of Embodiment.

Therefore, compared with Comparative Examples 1 to 8, it can be confirmed that Embodiment is excellent enough to significantly reduce the concentrations of COD, SS, T-N and T-P after treatment with the method of the present invention.

Meanwhile, the above detailed description should not be construed as limiting in all respects and should be considered as illustrative. The scope of the invention should be determined by rational interpretation of the appended claims, and all changes within the equivalent scope of the invention are included in the scope of the invention.

What is claimed is:

1. A method of purifying lake water using nano and micro bubble comprising the steps of:
contacting a first microbial fermentation broth to the green algae-generating treatment water area or the malodor-generating treatment water area by spraying means so that the green algae components and the malodorous components are decomposed (S10);
treating with nano bubbles in which nano bubbles generated by a nano-micro bubble generator selectively generating nano bubbles and micro bubbles are introduced into the lower portion of the treatment water area (S20); and
treating with micro bubbles mixed with microorganisms in which micro bubbles mixed with a second microbial fermentation broth are introduced into the lower portion of the treatment water area from a mixer in which micro bubbles generated by the nano-micro bubble generator and the second microbial fermentation broth supplied from a microbial injection unit are mixed (S30).

2. The method of purifying lake water using nano and micro bubble according to claim 1,
wherein the mixer unit is characterized in that it is provided with a stirrer unit for stirring the water formed with micro bubbles and the second microbial fermentation liquid.

3. The method of purifying lake water using nano and micro bubble according to claim 1, wherein the first microorganism fermentation broth is characterized in that it is manufactured through the steps of:
obtaining a microbial fermented seed liquid through a fermentation and aging process by adding molasses and water to a mixed raw material wherein Lespedeza bicolor leaves, Lotus leaves, Houttuynia cordata, Scutellaria baicalensis, and Tabasheer are mixed; and
obtaining a microbial fermentation broth containing Lactobacillus paracasei, Lactobacillus parafarraginis, and Lactobacillus havinensis wherein the microbial fermented seed liquid is filtered to obtain a microbial stock solution, and purified water and bay salt is added to the microbial stock solution followed by fermentation and aging.

4. The method of purifying lake water using nano and micro bubble according to claim 1, wherein the second microbial fermentation broth is characterized by being cultivated after mixing of Lactobacillus harbinensis with Saccharomycopsis schoenii.
